(19) United States
(12) Patent Application Publication
(10) Pub. No.: US 2015/0344645 A1
(43) Pub. Date: Dec. 3, 2015

(54) MOLDED ARTICLE

(71) Applicant: Asahi Kasei Chemicals Corporation, Tokyo (JP)

(72) Inventor: Katsura TSUJIMOTO, Tokyo (JP)

(73) Assignee: Asahi Kasei Chemicals Corporation, Tokyo (JP)

(21) Appl. No.: 14/721,769

(22) Filed: May 26, 2015

(30) Foreign Application Priority Data
May 27, 2014 (JP) 2014-109478

(51) Int. Cl. C08J 5/00

(52) U.S. Cl. CPC C08J 5/00; C08J 2333/12

(57) ABSTRACT

A molded article contains a methacrylic resin composition containing a methacrylic resin, and has a joining portion for being joined to a different member in at least part of the molded article, wherein a thickness t (mm) of the molded article excluding the joining portion and a resin flow length L (mm) of the molded article satisfy relationships of formulae (1) and (2) below:

t<4.0 (1)

L/t>100 (2),
the methacrylic resin composition has a melt mass-flow rate value a (g/10 min) and a melt mass-flow rate value b (g/10 min) which satisfy relationships of formulae (3) and (4) below:

5.0<b/a (3)

0.3<a<15 (4)

wherein the melt mass-flow rate value a is determined at a load of 3.80 kgf and a test temperature of 230° C., and the melt mass-flow rate value b is determined at a load of 10.19 kgf and a test temperature of 230° C. according to JIS K7210:1999.

### BACKGROUND OF THE INVENTION

1. Field of the Invention

The present invention relates to a molded article.

2. Description of the Related Art

Methacrylic resin compositions as transparent resins are characterized by having high light transmittance, weatherability, and rigidity than those of other plastic transparent resins, and have been used in broad applications such as vehicle parts, lighting apparatuses, construction materials, advertising displays, nameplates, paintings, and display device windows.

Methacrylic resin compositions have high scratch resistance derived from high surface hardness to attain good appearances of articles. Because of these thereof, methacrylic resin compositions are used in design parts for home appliances and office automation products and design parts for interior and exterior accessories for vehicles among these.

Most of the design parts are parts for accessories mounted on other parts and do not serve as parts for reinforcing the strength of products. Therefore, the design parts are designed in view of a design plan that design parts have minimum strength to be bearable in practical use. For such reasons, the design parts in design do not need to have great section moduli, so that most of the design parts have thin elongate shapes.

Moreover, the design parts are often molded with a single gate to prevent poor appearances of design surfaces thereof caused by generation of weld lines.

If design parts are prepared with a methacrylic resin material by such molding with a single gate, a methacrylic resin material having high fluidity and molding properties is typically selected.

Meanwhile, the design parts may be joined or bonded to other parts.

Examples of methods of joining or bonding of the design parts and other parts include bonding with a double-sided adhesive tape. In articles requiring more secure joining, methods of joining to other parts through the so-called snap-fit structures or press fitting of parts alone, or in combination with bonding with a double-sided adhesive tape are used.

In the method of joining a design part to another part through a snap-fit structure or press fitting of parts, the material used should have high fatigue resistance. To satisfy such a requirement, high molecular weight resins are typically used as the material used in this method (see Purasuchikkuseihinno Kyodosekkeito Toraburutaisaku (Design of Strength of Plastic Articles And Troubleshooting), NTS, Inc., p. 275, and Porimazairyono Rekkakaisekito Shinraisei (Analysis of Degradation of Polymer Materials And Its Reliability), NTS, Inc., p. 148, for example).

Typically, such high molecular weight resins are also selected in preparation of a molded article comprising a methacrylic resin composition used in the method of joining a design part to another part through the snap-fit structure or press fitting of parts.

Unfortunately, the high molecular weight resins typically have disadvantages of low fluidity and thus low molding properties.

Such low fluidity of the resin may cause short shot particularly if thin elongate molded articles are molded through a single gate in which a melted resin should be injected from one side of the cavity of the metal mold.

Even if the resin reaches a flow end, significant molding distortion may be caused to generate warpage due to this molding distortion. In addition, risks such as solvent cracking are increased in molded articles which may be put into contact with an organic solvent.

Furthermore, the high molecular weight resins, which have low fluidity, are typically difficult to mold while sufficient pressure is being applied to the resins. If the thin elongate molded articles molded of such resins have joining portions for being joined to different members, such as snap-fit structures, and the joining portions cannot be molded while sufficient pressure is being applied to the resins, the joining portions of the thin elongate molded articles cannot attain sufficient strength for practical use irrespective of use of the high molecular weight resins.

Conversely, methacrylic resins having high fluidity reduce the risks such as short shot and molding distortion described above.

Unfortunately, the high fluidity of the methacrylic resins of this type is typically attained by a reduction in the molecular weight of the resin. Accordingly, the resulting molded articles do not attain high fatigue resistance in general, causing problems in cases where entanglement of molecules is an important factor.

Namely, if thin elongate molded articles having joining portions such as snap-fit structures are prepared with methacrylic resins having high fluidity, the molded articles can be attained; however, the joining portions do not attain fatigue resistance as high as originally required as the joining portions such as snap-fit structures.

Accordingly, an object of the present invention is to provide a molded article comprising a methacrylic resin composition and having a thin elongate shape which has a joining portion for being joined to a different member, and has sufficient fatigue resistance for practical use.

### SUMMARY OF THE INVENTION

The present inventors, who have conducted extensive research to solve the problems of the related art, have found that a methacrylic resin composition having a pseudoplastic in a specific range can solve the problems in the related art described above, and can attain practically sufficient fatigue resistance of a joining portion, and have solved the problems in the related art.

Namely, the present invention is as follows:

[1]

A molded article comprising a methacrylic resin composition comprising a methacrylic resin and a joining portion for being joined to a different member in at least part of the molded article,

wherein a thickness t (mm) of the molded article excluding the joining portion and a resin flow length L (mm) of the molded article satisfy relationships expressed by formulae (1) and (2) below:

t<4.0 (1)

L/t>100 (2), and

the methacrylic resin composition has a melt mass-flow rate value a (g/10 min) and a melt mass-flow rate value b (g/10 min) which satisfy relationships expressed by formulae (3) and (4) below:

5.0<b/a (3)

0.3<a<15 (4)

wherein the melt mass-flow rate value a is determined at a load of 3.80 kgf and a test temperature of 230° C., and the melt mass-flow rate value b is determined at a load of 10.19 kgf and a test temperature of 230° C. according to JIS K7210:1999.
[2]

The molded article according to [1], wherein the methacrylic resin contained in the methacrylic resin composition comprises

a monomer unit of a methacrylic acid ester of 80 to 99.9% by mass, and

a monomer unit of at least one of a different vinyl monomer which is copolymerizable with the methacrylic acid ester of 0.1 to 20% by mass.

[3]

The molded article according to [2], wherein the methacrylic acid ester is a methyl methacrylate or an ethyl methacrylate.

[4]

The molded article according to [2] or [3], wherein the vinyl monomer is a methyl acrylate or an ethyl acrylate.

[5]

The molded article according to any one of [1] to [4], wherein the joining portion is a projection structure.

[6]

The molded article according to [5], wherein the projection structure is any one selected from the group consisting of a snap-fit male element, a positioning column, boss, or rib, an engaging male or female portion, and a cylindrical boss for self-tapping.

[7]

The molded article according to any one of [1] to [4], wherein the joining portion is a through hole structure or a non-through hole structure.

[8]

The molded article according to [7], wherein the through hole structure or the non-through hole structure is any one selected from the group consisting of a snap-fit female element, a through hole for self-tapping, a non-through hole for self-tapping, and a female portion for press fitting.

[9]

The molded article according to any one of [1] to [8], wherein the molded article is any one selected from the group consisting of interior or exterior members for vehicles, lens covers, housing members, and lighting covers.

[10]

The molded article according to any one of [1] to [9], wherein the molded article is any interior or exterior member for vehicles selected from the group consisting of visors, dashboard panels, display parts, pillars, head lamp covers, tail lamp covers, side lamp covers, tail lamp garnishes, front lamp garnishes, pillar garnishes, front grilles, rear grilles, and number plate garnishes.

[11]

The molded article according to any one of [1] to [10], wherein the molded article is any exterior member for vehicles selected from the group consisting of visors, pillars, head lamp covers, tail lamp covers, side lamp covers, tail lamp garnishes, front lamp garnishes, pillar garnishes, front grilles, rear grilles, and number plate garnishes.

The present invention can attain a thin elongate molded article and having a joining portion for being joined to a different member, and having practically sufficient fatigue resistance.

### BRIEF DESCRIPTION OF DRAWINGS

FIG. 1 shows a schematic perspective view illustrating one example of a molded article according to the present invention; and

FIG. 2 shows a schematic view illustrating one example of a molded article used in the determination of the vibration fatigue resistance of the joining portion in Examples of the present invention. In the drawings, the numeric values are expressed in millimeters.

### DETAILED DESCRIPTION OF THE PREFERRED EMBODIMENT

Hereinafter, an embodiment for implementing the present invention (hereinafter, referred to as “the present embodiment”) will be described in detail, but the present invention will not be limited to the following description, and can be modified in various ways within the scope of the gist for implementation.

### [Molded Article]

The molded article according to the present embodiment comprises the methacrylic resin composition comprising a methacrylic resin, and a joining portion for being joined to a different member in at least part of the molded article. The thickness t (mm) of the molded article excluding the joining portion and the resin flow length L (mm) of the molded article satisfy relationships expressed by formulae (1) and (2) below:

t<4.0 (1)

L/t>100 (2).

The methacrylic resin composition has a melt mass-flow rate value a (g/10 min) and a melt mass-flow rate value b (g/10 min) which satisfy relationships expressed by formulae (3) and (4) below:

5.0<b/a (3)

0.3<a<15 (4),

wherein the melt mass-flow rate value a is determined at a load of 3.80 kgf and a test temperature of 230° C., and the melt mass-flow rate value b is determined at a load of 10.19 kgf and a test temperature of 230° C. according to JIS K7210:1999.

The molded article according to the present embodiment refers to a so-called thin elongate molded article.

Throughout the specification, the term “thin elongate (shape)” indicates that the thickness of the thinnest portion excluding the portion of the molded article having a channel structure is less than 4 mm and the length of the molded article in the resin flow direction, i.e., resin flow length (L), is larger than the length (V) of the molded article in the direction orthogonal to the resin flow direction in the cross section of the molded article cut in the resin flow direction.

The resin flow length L (mm) and the length V (mm) in the direction orthogonal to the resin flow direction has a relationship expressed by more preferably L/V>1.2, still more preferably L/V>1.3.

In the molded article according to the present embodiment, the thickness t (mm) of the molded article excluding the joining portion, and the resin flow length L (mm) of the molded article has a relationship expressed by L/t>100, more preferably L/t>102, still more preferably L/t>104.

### (Thickness t)

The thickness t of the molded article according to the present embodiment refers to the thickness of the molded article excluding the joining portion of the molded article. This thickness is defined as the thickness of the thin portion of the molded article excluding the portion having a channel structure, in other words, the thickness of the thinnest portion in the cross section of the molded article according to the present embodiment cut in the direction orthogonal to the resin flow direction.

The thin elongate molded article may have a partially leaf-veined channel structure to assist the flow of the resin. In the molded article according to the present embodiment, the thickness t is the thickness of a thin portion of the molded article excluding the portion having the channel structure rather than the thickness of the portion having the channel structure.

### (Resin Flow Length L)

The resin flow length L corresponds to the flow distance from the gate feeding the resin to the distal flow end of the resin in preparation of the molded article according to the present embodiment by injection molding.

If a plurality of gates are used, the largest distance is defined as the resin flow length L.

If a plurality of gates are used, the largest distance L is determined by a method of examining the distances of the respective gates by reducing the amount of a resin to be injected from an injection molding machine to intentionally cause short shot, for example.

(Joining Portion for being Joined to Different Member)

The molded article according to the present embodiment has a joining portion for being joined to a different member.

The joining portion refers to a portion of the molded article according to the present embodiment for physically connecting the molded article according to the present embodiment to a different member.

Examples of the joining portion include projection structures, through hole structures, and non-through hole structures for connecting the molded article to a different member.

Examples of the projection structure include, but are not limited to, snap-fit male elements, positioning columns, positioning cylindrical bosses or ribs, engaging male or female portions, and cylindrical bosses for self-tapping.

Snap-fitting is one of mechanically joining methods used for connecting metal or plastic parts, which are forced into their mating portions using the elasticity of the material to fix the parts.

Examples of the through hole structure and the non-through hole structure include, but are not limited to, snap-fit female elements, through holes for self-tapping, non-through holes for self-tapping, and female portions for press fitting.

The joining portion of the molded article according to the present embodiment has an object to physically connect the molded article to a different member to prevent the molded article from coming apart therefrom, and in addition, has a function to align the molded article with the different member during attachment of the molded article to the different member.

The joining portion repeatedly receives stress from repeating attachment and detachment of the molded article according to the present embodiment to and from the different member, or is stored for a long time while stress is being applied to the joining portion. For this reason, typically, the joining portion should be formed, by molding, of a raw material having high long-term physical properties such as fatigue resistance and creep properties.

Accordingly, the methacrylic resin composition used as a material for the molded article according to the present embodiment requires high fluidity to prepare a thin elongate molded article and, at the same time, requires high fatigue resistance and creep properties.

High fluidity is incompatible with high fatigue resistance and creep properties, and any material satisfying these properties at the same time has not been attained in the related art. The present inventors, who have conducted extensive research, have specified the physical properties of the methacrylic resin composition described later and achieved the material having both high fluidity and high fatigue resistance and creep properties.

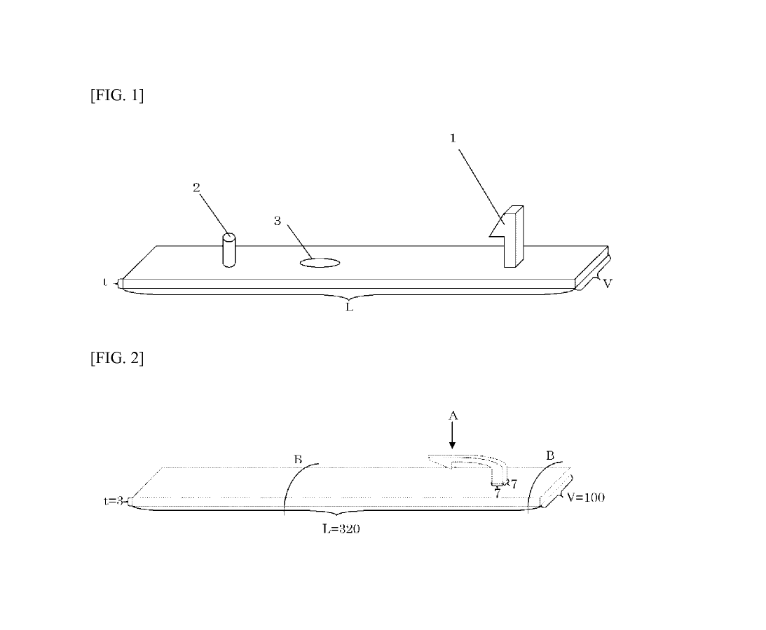

FIG. 1 illustrates a schematic perspective view of one example of the molded article according to the present embodiment.

The molded article illustrated in FIG. 1 has a joining portion for being joined to a different member at least in part of the molded article. The molded article is a thin elongate molded article including a plate and predetermined joining portions thereon, such as joining portions 1 to 3, as illustrated in FIG. 1, wherein excluding the joining portion, the molded article has a thickness t (mm) of t<4.0; the thickness t (mm) and the resin flow length L (mm) satisfy the relationship expressed by L/t>100; and the resin flow length L (mm) and the length V (mm) in the direction orthogonal to the resin flow direction satisfy the relationship expressed by L/V>1.

Joining portion 1 is one example of the projection structure, i.e., a snap-fit male element formed to be joined to the snap-fit female element of a different member.

Joining portion 2 is another example of the projection structure, i.e., a cylindrical boss formed to bed joined to a through hole or non-through hole of a different member.

Joining portion 3 is one example of the through hole structure, i.e., a through hole for self-tapping formed to be joined to a projection structure of a different member.

The molded article according to the present embodiment is aligned with a different member by means of the joining portion, and can be connected to the different member by a predetermined method.

Examples of the connection method include a welding method involving aligning and joining at the joining portion followed optionally by laser welding or hot plate welding, and a method involving bonding with an adhesive or tacky component using an adhesive, a double-sided adhesive tape, or the like.

The welding method requires a special apparatus or technical training, and has many restrictions on the molded article in design while the bonding method may have insufficient joining strength or insufficient long-term reliability of joining strength. From such a viewpoint, the connection method is selected according to the purpose.

The bonding method can be used to reinforce the joining portion or other portions of the molded article according to the present embodiment.

### (Pseudoplastic of Methacrylic Resin Composition)

The molded article according to the present embodiment can be prepared through molding of a methacrylic resin composition comprising a methacrylic resin.

As described above, the methacrylic resin composition used in the molded article according to the present embodiment requires high fluidity and high long-term properties such as fatigue resistance and creep properties, which are incompatible with each other. These seemingly incompatible properties, however, can be compatible in a methacrylic resin composition having a pseudoplastic within the following specific range.

The methacrylic resin composition used in the molded article according to the present embodiment has a melt mass-flow rate value a (g/10 min) within the range of 0.3<a<15, which is determined according to JIS K7210:1999 at a load of 3.80 kgf and a test temperature of 230° C.

At a>0.3, in preparation of a thin elongate molded article formed of the molded article according to the present embodiment, the resin can reach the flow end to effectively prevent short shot.

The resin can reach the flow end to effectively prevent generation of molding distortion in the resulting molded article. Moreover, risks such as warpage and solvent cracking after molding can be reduced.

Particularly if a portion corresponding to the joining portion is located at or near the flow end in the metal mold, the resin can be significantly transferred to the portion corresponding to the joining portion in the metal mold to attain practically sufficient joining strength.

At a<15, the methacrylic resin in the methacrylic resin composition can attain sufficient fluidity of the methacrylic resin composition and attain desired long-term properties of the joining portion without significantly reducing the molecular weight of the methacrylic resin.

The methacrylic resin composition used in the molded article according to the present embodiment has a melt mass-flow rate of preferably 0.4<a<13, more preferably 0.5<a<12.

Furthermore, the methacrylic resin composition used in the molded article according to the present embodiment has a relationship of 5.0<b/a between the melt mass-flow rate value b (g/10 min) and the melt mass-flow rate value a determined according to JIS K7210:1999 at a load of 10.19 kgf and a test temperature of 230° C.

The relationship b/a is one index indicating the pseudoplastic of a melted resin. A larger value indicates that a reduction in the viscosity of the resin by a shear force is larger.

The traditional known acrylic resins commercially available have a relationship b/a of 5.0 or less, which indicates that a reduction in the viscosity of the resin by a shear force is small. This is because these traditional known acrylic resins have narrow molecular weight distribution.

If the relationship of 5.0<b/a is satisfied, fluidity is compatible with long-term properties.

The methacrylic resin composition used in the molded article according to the present embodiment is preferably 5.1<b/a, more preferably 5.2<b/a.

To satisfy the relationship expressed by 0.3<a<15 and the relationship expressed by 5.0<b/a, which is required for compatibility of fluidity and long-term properties, the pseudoplastic of the melted resin should be increased, namely, the molecular weight distribution of the methacrylic resin composition should be widened.

Examples of a method of preparing a methacrylic resin having wide molecular weight distribution include a method disclosed in WO 2007/60891 in which methacrylic resins having extremely different molecular weights are continuously suspension polymerized one by one in a single polymerization reaction tank. If a methacrylic resin is prepared by the method, the melt mass-flow rate value a and the value of b/a can be controlled to fall within the ranges above.

Another method of preparing a methacrylic resin composition having wide molecular weight distribution as described above include a method of polymerizing methacrylic resins having different molecular weights by continuous bulk polymerization or continuous solution polymerization in two or more polymerization reaction tanks arranged in series, merging and mixing the resulting polymerization solutions containing the respective polymerization products, and removing the solvent(s) and non-reacted monomers to prepare a polymerization product.

Examples of a polymerization apparatus equipped with two or more polymerization reaction tanks arranged in series include apparatuses described in Japanese Patent Application Laid-Open Nos. 2012-153805 and 2012-153807.

Other examples of a method of preparing a methacrylic resin composition having wide molecular weight distribution described above include a method of continuously polymerizing methacrylic resins having different molecular weights by continuous bulk polymerization or continuous solution polymerization in two or more polymerization reaction tanks arranged in series.

Examples of a polymerization apparatus equipped with two or more polymerization reaction tanks arranged in series include Japanese Patent Application Laid-Open No. 2012-102190.

Still other examples of a method of preparing a methacrylic resin composition having wide molecular weight distribution described above include a method of compounding two or more methacrylic resin compositions having different molecular weights with an extruder and the like, and a method of performing polymerization while the gradient of the temperature, the concentration of the monomer, or the concentration of the catalyst, or a combination thereof is provided in the reaction apparatus.

If a methacrylic resin is prepared by any one of the various methods described above, the melt mass-flow rate value a and the value of b/a can be controlled to fall within the ranges above.

To effectively control the melt mass-flow rate value a and the value of b/a, the temperature condition and the amount of the methacrylic resin composition ejected during extrusion of the methacrylic resin composition in molding of the methacrylic resin composition into the molded article according to the present embodiment are adjusted, and the molding temperature and the molding residence time are adjusted in molding of the methacrylic resin composition into the molded article.

Specifically, it is preferred that the temperature condition during extrusion be 300° C. or less and/or the amount of the methacrylic resin composition ejected be 3 kg/hr or more. It is preferred that the molding temperature be 290° C. or less and/or the molding residence time be 15 minutes or less during molding.

If the temperature condition and the amount of the methacrylic resin composition ejected during extrusion of the methacrylic resin composition and the molding temperature and the molding residence time during molding of the methacrylic resin composition into the molded article are controlled to be within the ranges above, the melt mass-flow rate value a and the value of b/a can be controlled to fall within appropriate ranges specified in the present invention, and can prevent discoloring of the methacrylic resin to attain high appearance properties unique to the methacrylic resin composition.

### (Methacrylic Resin Composition)

The molded article according to the present embodiment is prepared through molding of a methacrylic resin composition and comprises the methacrylic resin composition. The methacrylic resin composition comprises a methacrylic resin.

Preferably, the methacrylic resin comprises a monomer unit of a methacrylic acid ester of 80 to 99.9% by mass, and a monomer unit of at least one of a different vinyl monomer which is copolymerizable with the methacrylic acid ester of 0.1 to 20% by mass.

Examples of the methacrylic acid ester include, but are not limited to, butyl methacrylate, ethyl methacrylate, methyl methacrylate, propyl methacrylate, isopropyl methacrylate, cyclohexyl methacrylate, phenyl methacrylate, 2-ethylhexyl methacrylate, t-butylcyclohexyl methacrylate, benzyl methacrylate, and 2,2,2-trifluoroethyl methacrylate. Preferred are methyl methacrylate and ethyl methacrylate because of availability and cost.

These methacrylic acid ester monomers can be used singly or in combinations of two or more.

The content of the monomer unit of a methacrylic acid ester is preferably 99.9% by mass or less of the methacrylic resin contained in the methacrylic resin composition. If the content of the monomer unit of the methacrylic acid ester is 99.9% by mass or less, decomposition of the resin during molding of the resin composition can be prevented to effectively prevent generation of volatile methacrylic acid ester monomers and thus generation of molding failures called silver streaks.

If the content of the monomer unit of the methacrylic acid ester is 80% by mass or more, heat resistance typically required for the molded article can be ensured.

Sufficient heat resistance of the molded article can also ensure rigidity, and effectively prevent a reduction in connection strength of the joining portion particularly at high temperatures.

The content of the monomer unit of the methacrylic acid ester is more preferably 82 to 99.9% by mass, still more preferably 84 to 99.8% by mass.

Examples of the vinyl monomer which is copolymerizable with the methacrylic acid ester include, but are not limited to, acrylic acid ester monomers having one acrylate group such as methyl acrylate, ethyl acrylate, n-propyl acrylate, n-butyl acrylate, sec-butyl acrylate, and 2-ethylhexyl acrylate.

Other examples thereof include the following acrylic acid ester monomers: ethylene glycol or its oligomers thereof having both terminal hydroxyl groups esterified with acrylic acid or methacrylic acid and having two or more (meth)acrylate groups (such as ethylene glycol di(meth)acrylate, diethylene glycol di(meth)acrylate, triethylene glycol di(meth)acrylate, and tetraethylene glycol di(meth)acrylate); acrylic acid ester monomers prepared by esterification of two hydroxyl groups of alcohol with acrylic acid or methacrylic acid (such as neopentyl glycol di(meth)acrylate and di(meth)acrylate); and acrylic acid ester monomers prepared by esterification of polyhydric alcohol derivatives with acrylic acid or methacrylic acid (such as trimethylolpropane and pentaerythritol).

Particularly preferred are methyl acrylate, ethyl acrylate, and n-butyl acrylate, and more preferred are methyl acrylate and ethyl acrylate because of availability.

These monomers can be used singly or in combinations of two or more.

The content of the monomer unit of the different vinyl monomer which is copolymerizable with one methacrylic acid ester is preferably 0.1% by mass or more. At a content of 0.1% by mass or more, decomposition of the resin during molding of the resin composition can be prevented to effectively prevent generation of a volatile methacrylic acid ester monomer and thus generation of a molding failure called a silver streak. At a content of 20% by mass or less, heat resistance typically required for the molded article can be ensured.

Sufficient heat resistance of the molded article can also ensure rigidity, and effectively prevent a reduction in connection strength of the joining portion particularly at high temperatures.

The content of the monomer unit of the different vinyl monomer which is copolymerizable with the methacrylic acid ester is more preferably 0.1 to 18% by mass, more preferably 0.2 to 16% by mass.

Examples of the vinyl monomer (excluding acrylic acid ester monomers) which is copolymerizable with the methacrylic acid ester include, but are not limited to, α,β-unsaturated acids such as acrylic acid and methacrylic acid; divalent carboxylic acids containing unsaturated groups such as maleic acid, fumaric acid, itaconic acid, and cinnamic acid and alkyl esters thereof; styrene monomers such as styrene, o-methylstyrene, m-methylstyrene, p-methylstyrene, 2,4-dimethylstyrene, 2,5-dimethylstyrene, 3,4-dimethylstyrene, 3,5-dimethylstyrene, p-ethylstyrene, m-ethylstyrene, o-ethylstyrene, p-tert-butylstyrene, and isopropenylbenzene (α-methylstyrene); aromatic vinyl compounds such as 1-vinylnaphthalene, 2-vinylnaphthalene, 1,1-diphenylethylene, isopropenyltoluene, isopropenylethylbenzene, isopropenylpropylbenzene, isopropenylbutylbenzene, isopropenylpentylbenzene, isopropenylhexylbenzene, and isopropenyloctylbenzene; vinyl cyanide compounds such as acrylonitrile and methacrylonitrile; unsaturated carboxylic acid anhydrides such as maleic anhydride and itaconic anhydride; maleimide and N-substituted maleimides such as N-methylmaleimide, N-ethylmaleimide, N-phenylmaleimide, and N-cyclohexylmaleimide; amides such as acrylamide and methacrylamide; and polyfunctional monomers such as divinylbenzene.

To enhance the properties of the methacrylic resin such as heat resistance and processability, vinyl monomers other than the vinyl monomers exemplified above can be added to the methacrylic resin to be copolymerized.

These acrylic acid ester monomers copolymerizable with the methacrylic acid ester and these vinyl monomers other than the acrylic acid ester monomers exemplified above can be used singly or in combinations of two or more.

The methacrylic resin contained in the methacrylic resin composition can be prepared by bulk polymerization, cast polymerization, or suspension polymerization, but the preparation method are not limited to these methods.

(Components which can be Mixed in Methacrylic Resin)

### <Other Resins>

Other resins known in the related art can be mixed with the methacrylic resin composition in the range not impairing the advantageous effects of the present invention.

Any known curable resins and thermoplastic resins can be suitably used as such other resins without limitation.

Examples of the thermoplastic resins include, but are not limited to, polypropylene resins; polyethylene resins; polystyrene resins; syndiotactic polystyrene resins; ABS resins; methacrylic resins; AS resins, BAAS resins; MBS resins; AAS resins; biodegradable resins; polycarbonate-ABS resin alloys; polyalkylene arylate resins such as polybutylene terephthalate, polyethylene terephthalate, polypropylene terephthalate, polytrimethylene terephthalate, and polyethylene naphthalate; polyamide resins; polyphenylene ether resins; polyphenylene sulfide resins; and phenol resins.

Particularly, AS resins and BAAS resins are preferred to enhance fluidity, ABS resins and MBS resins are preferred to enhance impact resistance, and polyester resins are preferred to enhance resistance against chemicals.

Polyphenylene ether resins, polyphenylene sulfide resins, and phenol resins enhance flame retardancy.

Examples of the curable resins include, but are not limited to, unsaturated polyester resins, vinyl ester resins, diallyl phthalate resins, epoxy resins, cyanate resins, xylene resins, triazine resins, urea resins, melamine resins, benzoguanamine resins, urethane resins, oxetane resins, ketone resins, alkyd resins, furan resins, styrylpyridine resins, silicon resins, and synthetic rubber.

These resins can be used singly or in combinations of two or more.

### <Additives>

To give predetermined various properties such as rigidity and dimensional stability, a variety of additives can be mixed with the methacrylic resin composition in the range not impairing the advantageous effects of the present invention.

Examples of the additives include, but are not limited to, plasticizers such as phthalic acid ester plasticizers, fatty acid ester plasticizers, trimellitic acid ester plasticizers, phosphoric acid ester plasticizers, and polyester plasticizers; mold release agents such as higher fatty acid mold release agents, higher fatty acid ester mold lubricants, and mold lubricants of mono-, di-, or triglyceride of higher fatty acids; antistats such as polyether antistats, polyether ester antistats, polyether ester amide antistats, alkyl sulfonate antistats, and alkylbenzene sulfonate antistats; antioxidants; ultraviolet absorbents; stabilizers such as heat stabilizers and light stabilizer; flame retardants; flame retardant aids; curing agents; curing accelerators; conductors; stress relaxing agents; crystallization accelerators; hydrolysis inhibitors; lubricants; impact resistant agents; sliding property improvers; compatibilizers; nucleus agents; strengthening agents; reinforcing agents; flow controllers; dyes; sensitizers; coloring pigments, rubber polymers; thickeners; anti-sedimentation additives; dipping inhibitors; fillers; antifoaming agents; coupling agents; rust inhibitors; antibacterial and anti-mold agents; dirt resistant agents; conductive polymers; and carbon black.

Examples of the dyes include, but are not limited to, the following.

Examples of red dyes include Solvent red 52, Solvent red 111, Solvent red 135, Solvent red 145, Solvent red 146, Solvent red 149, Solvent red 150, Solvent red 151, Solvent red 155, Solvent red 179, Solvent red 180, Solvent red 181, Solvent red 196, Solvent red 197, Solvent red 207, Disperse Red 22, Disperse Red 60, and Disperse Red 191 according to the Colour Index.

Examples of blue dyes include Solvent Blue 35, Solvent Blue 45, Solvent Blue 78, Solvent Blue 83, Solvent Blue 94, Solvent Blue 97, Solvent Blue 104, and Solvent Blue 105 according to the Colour Index.

Examples of yellow dyes include Disperse Yellow 160, Disperse Yellow 54, Disperse Yellow 160, and Solvent yellow 33 according to the Colour Index.

Examples of green dyes include Solvent Green 3, Solvent Green 20, and Solvent Green 28 according to the Colour Index.

Examples of violet dyes include Solvent Violet 28, Solvent Violet 13, Solvent Violet 31, Solvent Violet 35, and Solvent Violet 36 according to the Colour Index.

These dyes of the respective colors can be used singly or in combinations of two or more.

Any dye can be used without limitation. Preferred are those selected from the group consisting of anthraquinone dyes, heterocyclic compound dyes, and perinone dyes from the viewpoint of weatherability.

Examples of anthraquinone dyes include Solvent Violet 36, Solvent Green 3, Solvent Green 28, Solvent Blue 94, Solvent Blue 97, and Disperse Red 22 according to the Colour Index.

Examples of heterocyclic compound dyes include Disperse Yellow 160 according to the Colour Index.

Examples of perinone dyes include Solvent red 179 according to the Colour Index.

These dyes can be used singly or in combinations of two or more.

The carbon black is used to give the color of black or jet blackness to the methacrylic resin composition.

Examples of carbon black include, but are not limited to, those coated with surface coating agents to appear deeper jet blackness.

The content of carbon black is preferably 0.01% by mass or more based on the total amount of the methacrylic resin composition according to the present embodiment. At a content of carbon black of 0.01% by mass or more, particularly thin molded articles can have high shielding properties and keep high jet blackness.

Any type of carbon black can be used without limitation. Typically, commercial products for coloring resins can be used. Specifically, carbon black satisfying one or more of the following features can be suitable used: an arithmetic average particle size of 10 to 40 nm in observation with a microscope, a nitrogen adsorption specific surface area of 50 to 300 m²/g, which is specified in JIS K6217:2001, and a volatile content of 0.5 to 3% by mass in heating at 950° C. for 7 minutes.

Examples of a surface coating agent used in carbon black include, but are not limited to, zinc stearate, magnesium stearate, calcium stearate, oleamide, stearamide, palmitamide, methylenebisstearylamide, and ethylenebisstearylamide (EBS).

Among these surface coating agents, zinc stearate and EBS are more preferred to attain deeper jet blackness.

These surface coating agents can be used singly or in combinations of two or more.

Deeper jet blackness can be achieved by adding carbon black coated with a surface coating agent and a dye in combination to the methacrylic resin composition.

Examples of the flame retardant include, but are not limited to, cyclic nitrogen compounds, phosphorus flame retardants, silicon, polyhedral oligomeric silsesquioxanes or products thereof having a partially cleaved structure, and silica.

Examples of the heat stabilizer include, but are not limited to, antioxidants such as hindered phenol antioxidants and phosphorus process stabilizers. Preferred are hindered phenol antioxidants.

Examples of the hindered phenol antioxidants include, but are not limited to, pentaerythritol tetrakis[3-(3,5-di-tert-butyl-4-hydroxyphenyl)propionate], thiodiethylene bis[3-(3,5-di-tert-butyl-4-hydroxyphenyl)propionate], octadecyl 3-(3,5-di-tert-butyl-4-hydroxyphenyl)propionate, N,N′-hexane-1,6-diylbis[3-(3,5-di-tert-butyl-4-hydroxyphenylpropionamide)], 3,3′,3″,5,5′,5″-hexa-tert-butyl-a,a′,a″-(mesitylene-2,4,6-triyl)tri-p-cresol, 4,6-bis(octylthiomethyl)-o-cresol, 4,6-bis(dodecylthiomethyl)-o-cresol, ethylene bis(oxyethylene)-bis[3-(5-tert-butyl-4-hydroxy-m-tolyl)propionate], hexamethylene bis[3-(3,5-di-tert-butyl-4-hydroxyphenyl)propionate], 1,3,5-tris(3,5-di-tert-butyl-4-hydroxybenzyl)-1,3,5-triazine-2,4,6(1H,3H,5H)-trione, 1,3,5-tris[(4-tert-butyl-3-hydroxy-2,6-xylene)methyl]-1,3,5-triazine-2,4,6(1H,3H,5H)-trione, and 2,6-di-tert-butyl-4-(4,6-bis(octylthio)-1,3,5-triazine-2-ylamine)phenol. Preferred is pentaerythritol tetrakis[3-(3,5-di-tert-butyl-4-hydroxyphenyl)propionate].

Examples of the ultraviolet absorbents include, but are not limited to, benzotriazole compounds, benzotriazine compounds, benzoate compounds, benzophenone compounds, oxybenzophenone compounds, phenol compounds, oxazole compounds, malonic acid ester compounds, cyano acrylate compounds, lactone compounds, salicylic acid ester compounds, and benzoxazinone compounds. Preferred are benzotriazole compounds and benzotriazine compounds.

These compounds can be used singly or in combinations of two or more.

The ultraviolet absorbent has a melting point (Tm) of preferably 80° C. or more, more preferably 100° C. or more, still more preferably 130° C. or more, yet still more preferably 160° C. or more to prevent thermal deformation of the molded article.

The ultraviolet absorbing agent has a mass reduction rate, which is determined by heating at 20° C./min from 23° C. to 260° C., of preferably 50% or less, more preferably 30% or less, still more preferably 15% or less, yet still more preferably 10% or less, most preferably 5% or less to prevent generation of molding failures such as silver streaks of the molded article.

The content of the other resins and the additives in the methacrylic resin composition used to prepare the molded article according to the present embodiment is preferably 0 to 60 parts by mass, more preferably 0.01 to 34 parts by mass, still more preferably 0.02 to 25 parts by mass relative to 100 parts by mass of the methacrylic resin composition to keep the transparency of the methacrylic resin composition and prevent molding failures caused of bleed out and the like.

At the content within this numerical value range, the functions of the respective materials can be demonstrated.

### [Method of Preparing Molded Article]

The molded article according to the present embodiment is prepared through molding of the methacrylic resin composition.

The methacrylic resin composition is prepared by mixing the methacrylic resin, the various additives, and the predetermined other resins, and kneading the mixture.

The methacrylic resin composition can be prepared by kneading with a kneader such as an extruder, a heat roll, a kneader, a roller mixer, or a Banbury mixer.

Particularly, kneading with an extruder is preferred from the viewpoint of productivity.

The kneading temperature can be any preferred processing temperature for the methacrylic resin composition. The kneading temperature is in the range of preferably 140 to 300° C., more preferably 180 to 280° C.

To prepare the molded article according to the present embodiment, the methacrylic resin composition can be molded by injection molding, injection compression molding, gas assist injection molding, foam injection molding, or ultra-thin injection molding (ultra-high speed injection molding), for example.

In the present embodiment, if a molded article having a variety of joining portions illustrated in FIG. 1 is molded, the pseudoplastic of the methacrylic resin composition specified in the above range attains high fluidity and high molding properties of the methacrylic resin composition, and in turn, attains practically sufficient cyclic fatigue resistance and long-term physical properties of the joining portions.

### [Applications of Molded Article]

The molded article according to the present embodiment is used as thin elongate molded articles having a joining portion for being joined to a different member in applications to home appliances, office automation products, and vehicles.

For example, the molded article can be used as any one selected from the group consisting of interior or exterior members for vehicles, lens covers, housing members, and lighting covers.

Specifically, the molded article can be used as any interior or exterior member for vehicles selected from the group consisting of visors, dashboard panels, display parts, pillars, head lamp covers, tail lamp covers, side lamp covers, tail lamp garnishes, front lamp garnishes, pillar garnishes, front grilles, rear grilles, and number plate garnishes. The molded article can be suitably used as particularly any exterior member for vehicles selected from the group consisting of visors, pillars, head lamp covers, tail lamp covers, side lamp covers, tail lamp garnishes, front lamp garnishes, pillar garnishes, front grilles, rear grilles, and number plate garnishes.

### EXAMPLES

Hereinafter, the present embodiment will be specifically described by way of Examples and Comparative Examples, but the present embodiment will not be limited to these Examples described later.

### [Determination of Melt Mass-Flow Rate]

The melt mass-flow rate was determined as follows: test samples prepared in Examples and Comparative Examples described later were finely crushed with a nipper, and were dried at 80° C. under reduced pressure for 24 hours. The resulting products were used as samples.

In each of these samples, the melt mass-flow rate value a (g/10 min) was determined at a load of 3.80 kgf and a test temperature of 230° C. and the melt mass-flow rate value b (g/10 min) was determined at a load of 10.19 kgf and a test temperature of 230° C. according to JIS K7210:1999, and the value of b/a was calculated.

The results of measurement are shown in Table 4.

### [Determination of Spiral Length]

The resin pellets prepared in Examples and Comparative Examples described later were dried at 80° C. for 24 hours, and were evaluated for fluidity with the injection molding machine and the metal mold for measurement under the molding conditions shown below.

Specifically, the resin was injected into the central portion of the surface of the metal mold on the following conditions. A spiral molded article was extracted from the metal mold after 40 seconds after injection was completed. The length of the spiral portion was measured, and was used as an index in evaluation of fluidity.

The results of measurement are shown in Table 4. Injection molding machine: EC-100SX made by TOSHIBA MACHINE CO., LTD.

Metal mold for measurement: metal mold having an engraved Archimedean spiral groove (depth: 2 mm, width: 12.7 mm, starting from the center of the surface of the metal mold) on the surface of the metal mold

### Molding Conditions

Resin temperature: 250° C.

Metal mold temperature: 55° C.

Maximum injection pressure: 75 MPa

Injection time: 20 sec

The fluidity was considered good if the determined value of the length of the spiral portion in the evaluation was 26 cm or more.

A spiral length of 26 cm or more attained high fluidity during molding. A resin composition having such preferable fluidity prevented generation of molding failures such as a loose joining portion even in injection molded articles partially having a fine structure such as a joining portion, attaining preferable injection molded articles.

### [Determination of Vibration Fatigue Resistance of Joining Portion]

Test samples illustrated in FIG. 2, where were prepared in Examples and Comparative Examples described later, were evaluated for the cyclic fatigue resistance of the joining portion.

First, the portion B of a test sample in FIG. 2 was fixed with a metallic jig such that the test sample did not move during the test, and the jig was attached to a joining portion A in FIG. 2.

Next, the jig attached to the joining portion A was pulled under a constant stress of 20 MPa, and was released from the stress.

This operation of pulling and releasing the joining portion A was repeated at a rate of 1800 times/min to measure the number of operations when the joining portion A of the test sample was broken or when the amount of warpage exceeded ±8 mm.

The results of measurement are shown in Table 4.

In Table 4, the item “Molding of sample for test on cyclic fatigue resistance of joining portion” showed whether short shot occurred in the test sample to be used in the cyclic fatigue resistance test on the joining portion of the molded article or whether the test sample was prepared without molding failures such as silver streaks. The test sample was defined as “◯” if molded without molding failures, and was defined as “x” if molding failures were generated.

If the number of operations defined as the fatigue resistance of the joining portion of the molded article was 2.0×10⁵ or more, it was determined that the joining portion had sufficient fatigue resistance.

In FIG. 2, the numeric values are expressed in millimeters. In Table 4, 10̂5 indicates 10⁵.

Hereinafter, a method of preparing an injection molded article composed of a methacrylic resin composition will be described.

The abbreviations used below indicate the following compounds, respectively.

MMA: methyl methacrylate, MA: methyl acrylate, EA: ethyl acrylate

### Example 1

### Polymerization of Methacrylic Resin

The methacrylic resin was polymerized by suspension polymerization.

First, water (2 kg), tribasic calcium phosphate (65 g), calcium carbonate (39 g), and sodium lauryl sulfate (0.39 g) were placed in a 5 L container equipped with a stirrer, and were mixed with stirring to prepare a suspension.

Next, water (25 kg) was placed in a 60 L reactor, and was heated to 80° C. for preparation of suspension polymerization. After it was checked that the temperature of water reached 80° C. and was stable at this temperature, polymerization raw materials shown in “Polymer (I) for Resin 1” in Table 1 below and the total amount of the suspension were placed in the 60 L reactor, and were stirred.

While the reaction mixture was kept at about 80° C., suspension polymerization was performed. After 80 minutes had passed since the raw materials and the suspension were placed in the reactor, an exothermic peak was observed. After the exothermic peak was confirmed, the reaction mixture was heated to 92° C. at 1° C./min, was kept at a temperature of 92° C. to 94° C. for 30 minutes, and was cooled to 80° C. at 1° C./min.

After it was checked that the temperature reached 80° C., an ultraviolet absorbent ADEKA STAB LA-32 made by Adeka Corporation (2.5 g) and a lubricant KALCOL 8098 made by Kao Corporation (10 g) were added to the raw materials shown in “Polymer (II) for Resin 1” in Table 1 below, and the mixture was placed in the reactor. While the reaction mixture was kept at 80° C., suspension polymerization was further performed.

After 105 minutes after the raw materials for Polymer (II) were placed in the reactor, an exothermic peak was observed.

After the exothermic peak was confirmed, the reaction mixture was heated to 92° C. at 1° C./min, and was kept at 92° C. for 60 minutes.

The reaction mixture was then cooled to 50° C., and 20% by mass sulfuric acid was placed in the reactor to dissolve the suspension.

The polymerization reaction solution was extracted from the 60 L reactor, and was sieved through a sieve having an opening of 1.68 mm to remove large aggregates. The resulting product was separated through a Buchner funnel into an aqueous layer and a solid product to prepare polymer beads.

The polymer beads on the Buchner funnel were washed with distilled water (about 20 L) five times, and were dried in a steam oven to prepare polymer nanoparticles corresponding to Resin 1.

### <Granulation>

The polymer nanoparticles were melt kneaded in a twin screw extruder with a vent having a diameter of 30 mm. The twin screw extruder was set at an amount ejected of 9.8 kg/hr, a reduced pressure of 0.05 MPa, and a barrel temperature of 240° C. The strand was cut while being cooled in a cooling bath at a temperature of 45° C., thereby to prepare resin pellets corresponding to Resin 1.

### <Test Sample>

The resin pellets corresponding to Resin 1 were dried at 80° C. for 24 hours, and an injection molding machine EC100SX made by TOSHIBA MACHINE CO., LTD. was used to prepare a test sample having a shape illustrated in FIG. 2, satisfying the relationships expressed by L/t>100 and t<4.0 (mm), and having a joining portion for being joined to a different member under the following conditions:

### Injection Conditions

Molding temperature: 250° C.

Metal mold temperature: 60° C.

Maximum injection pressure: 120 MPa

Injection rate: 35 mm/sec

Injection time: 20 sec

Pressure kept at: 60 MPa

Time to keep pressure: 10 sec

Cooling time: 30 sec

### <Tests>

The melt mass-flow rate, the cyclic fatigue resistance of the joining portion, and the spiral length were determined by the following methods. The results are shown in Table 4.

### Examples 2 to 6, Comparative Example 1

In Examples 2 to 4, Example 5, Example 6, and Comparative Example 1, Resins 2 to 4 in Table 1, Resin 6 in Table 1, Resin 7 in Table 2, and Resin 5 in Table 1 were polymerized by the same method as in Example 1 to prepare polymer nanoparticles each corresponding to Resins 2 to 7.

Granulation, preparation of the test sample, and determination of the melt mass-flow rate, the cyclic fatigue resistance of the joining portion, and the spiral length were performed by the same methods as in Example 1.

The results are shown in Table 4.

### Comparative Example 2

Water (2 kg), tribasic calcium phosphate (65 g), calcium carbonate (39 g), and sodium lauryl sulfate (0.39 g) were placed in a 5 L container equipped with a stirrer, and were mixed with stirring to prepare a suspension.

Next, water (26 kg) was placed in a 60 L reactor, and was heated to 80° C. for preparation of suspension polymerization.

After it was checked that the temperature of water reached 80° C. and was stable at this temperature, polymerization raw materials shown in Table 3 below and the total amount of the suspension were placed in the 60 L reactor.

While the reaction mixture was kept at about 80° C., suspension polymerization was performed. After an exothermic peak was observed, the reaction mixture was heated to 92° C. at 1° C./min, and was kept at 92° C. for 60 minutes.

The reaction mixture was then cooled to 50° C., and 20% by mass sulfuric acid was placed in the reactor to dissolve the suspension.

The polymerization reaction solution was extracted from the 60 L reactor, and was sieved through a sieve having an opening of 1.68 mm to remove large aggregates. The resulting product was separated through a Buchner funnel into an aqueous layer and a solid product to prepare polymer beads.

The polymer beads on the Buchner funnel were washed with distilled water (about 20 L) five times, and were dried in a steam oven to prepare polymer nanoparticles corresponding to Resin 8.

Granulation, preparation of the test sample, and determination of the melt mass-flow rate, the cyclic fatigue resistance of the joining portion, and the spiral length were performed by the same methods as in Example 1.

The results are shown in Table 4.

### Comparative Examples 3 and 4

The raw materials shown in Table 3 below were polymerized by the same method as in Comparative Example 2 to prepare polymer nanoparticles each corresponding to Resins 9 and 10.

Granulation, preparation of the test sample, and determination of the melt mass-flow rate, the cyclic fatigue resistance of the joining portion, and the spiral length were performed by the same methods as in Example 1.

The results are shown in Table 4.

In Table 4, * indicates that evaluation was not performed.

TABLE 1

| | Raw materials for Polymer (I) g | | | | Raw materials for Polymer (II) g | | | |
|---|---|---|---|---|---|---|---|---|
| | | | Lauroyl | 2-Ethylhexyl | | | Lauroyl | n-Octyl |
| | MMA | MA | peroxide | thioglycolate | MMA | MA | peroxide | mercaptan |
| Resin 1 | 5500 | 0 | 40 | 90 | 15700 | 800 | 20 | 19 |
| Resin 2 | 5500 | 0 | 40 | 90 | 16100 | 400 | 20 | 19 |
| Resin 3 | 5500 | 0 | 40 | 114 | 16050 | 450 | 20 | 29 |
| Resin 4 | 6600 | 0 | 40 | 114 | 15355 | 45 | 20 | 20 |
| Resin 5 | 5500 | 0 | 40 | 114 | 16500 | 0 | 20 | 29 |
| Resin 6 | 7500 | 15 | 45 | 150 | 14000 | 25 | 15 | 14 |

TABLE 2

| | Raw materials for Polymer (I) g | | | | Raw materials for Polymer (II) g | | | |
|---|---|---|---|---|---|---|---|---|
| | | | Lauroyl | 2-Ethylhexyl | | | Lauroyl | n-Octyl |
| | MMA | EA | peroxide | thioglycolate | MMA | EA | peroxide | mercaptan |
| Resin 7 | 5500 | 25 | 40 | 90 | 15620 | 160 | 20 | 21 |

TABLE 3

Polymer raw material g

| | | | Lauroyl | n-Octyl |
|---|---|---|---|---|
| | MMA | MA | peroxide | mercaptan |
| Resin 8 | 21670 | 330 | 45 | 57 |
| Resin 9 | 21670 | 330 | 45 | 75 |
| Resin 10 | 21560 | 440 | 45 | 95 |

TABLE 4

| | | Total amount of | | | | | | | |
|---|---|---|---|---|---|---|---|---|---|
| | | polymers | | | | | | Molding of | Cyclic |
| | | Proportion | | | | | | sample for test | fatigue |
| | | of polymers | | | | | | on cyclic | resistance |
| | | in composition | | | | | | fatigue | of joining |
| | Resin | (% by mass) | | Melt mass-flow rate | | | Spiral | resistance of | portion |
| | used | MMA | MA or EA | a (g/10 min.) | b (g/10 min.) | b/a | length (cm) | joining portion | (×10\hat{ }5) times |
| Example 1 | Resin 1 | 96.4 | 3.6 | 0.6 | 3.5 | 5.9 | 28 | ◯ | 82.1 |
| Example 2 | Resin 2 | 98.2 | 1.8 | 0.5 | 3.2 | 6.4 | 27 | ◯ | 81.8 |
| Example 3 | Resin 3 | 98.0 | 2.0 | 1.8 | 9.4 | 5.2 | 33 | ◯ | 2.7 |
| Example 4 | Resin 4 | 99.8 | 0.2 | 1.7 | 9.8 | 5.7 | 31 | ◯ | 2.6 |
| Example 5 | Resin 6 | 99.6 | 0.4 | 0.7 | 4.7 | 6.7 | 31 | ◯ | 2.3 |
| Example 6 | Resin 7 | 98.5 | 1.5 | 0.7 | 4.3 | 6.1 | 28 | ◯ | 74.5 |
| Comparative | Resin 5 | 100 | 0 | * | * | * | * | X | * |
| Example 1 | | | | | | | | | |
| Comparative | Resin 8 | 98.5 | 1.5 | 1.8 | 7.9 | 4.4 | 25 | X | * |
| Example 2 | | | | | | | | | |
| Comparative | Resin 9 | 98.5 | 1.5 | 3.9 | 18.5 | 4.7 | 31 | ◯ | 1.3 |
| Example 3 | | | | | | | | | |
| Comparative | Resin 10 | 98.5 | 2.0 | 5.9 | 26.5 | 4.5 | 35 | ◯ | 0.8 |
| Example 4 | | | | | | | | | |

Examples 1 to 6 all satisfied the specified melt mass-flow rates and the relationships expressed by formulae 5.0<b/a and 0.3<a<15. The spiral length as an index of fluidity during molding was 26 cm or more, and the cyclic fatigue resistance was 2.0×10⁵ times or more. The results evidently showed that methacrylic resin compositions having high fluidity and thin elongate molded articles having joining portions having practically sufficient fatigue resistance were attained.

In Comparative Example 1, the resin decomposed during molding to generate a volatile methacrylic acid ester monomer, which caused silver streaks in the resulting injection molded article. The result evidently showed that the methacrylic resin composition in Comparative Example 1 did not have practically sufficient resistance against thermal decomposition. For this reason, the molded article was not evaluated for the melt mass-flow rate, the spiral length, and the cyclic fatigue resistance.

The comparison between Examples 1 to 6 and Comparative Example 2 showed that the methacrylic resin composition in Comparative Example 2 had a smaller spiral length as an index of fluidity during injection molding and did not have high fluidity. Any test sample used in the cyclic fatigue resistance test could not be prepared from this methacrylic resin composition due to insufficient fluidity.

The comparison between Examples 1 to 6 and Comparative Examples 3 and 4 showed that the methacrylic resin compositions in Comparative Examples 3 and 4 had high fluidity and the test samples used in the cyclic fatigue resistance were prepared with these methacrylic resin compositions while the methacrylic resin compositions had inferior cyclic fatigue resistance (the number of operations was smaller) and did not attain sufficient durability of the joining portions.

The present application is based on a Japanese patent applications (Japanese Patent Application No. 2014-109478) filed with the Japan Patent Office on May 27, 2014; the disclosure of which is hereby incorporated by reference.

### INDUSTRIAL APPLICABILITY

The molded article according to the present invention has industrial applicability to thin elongate parts having joining portions for physically connecting the thin elongate parts to different parts, such as parts for home appliances, office automation equipment, and vehicles.

1. A molded article comprising a methacrylic resin composition comprising a methacrylic resin, and a joining portion for being joined to a different member in at least part of the molded article,
wherein a thickness t (mm) of the molded article excluding the joining portion and a resin flow length L (mm) of the molded article satisfy relationships expressed by formulae (1) and (2) below:
t<4.0 (1)
L/t>100 (2), and
the methacrylic resin composition has a melt mass-flow rate value a (g/10 min) and a melt mass-flow rate value b (g/10 min) which satisfy relationships expressed by formulae (3) and (4) below:
5.0<b/a (3)
0.3<a<15 (4)
wherein the melt mass-flow rate value a is determined at a load of 3.80 kgf and a test temperature of 230° C., and the melt mass-flow rate value b is determined at a load of 10.19 kgf and a test temperature of 230° C. according to JIS K7210:1999.

2. The molded article according to claim 1, wherein the methacrylic resin contained in the methacrylic resin composition comprises
a monomer unit of a methacrylic acid ester of 80 to 99.9% by mass, and
a monomer unit of at least one of a different vinyl monomer which is copolymerizable with the methacrylic acid ester of 0.1 to 20% by mass.

3. The molded article according to claim 2, wherein the methacrylic acid ester is a methyl methacrylate and/or an ethyl methacrylate.

4. The molded article according to claim 2, wherein the vinyl monomer which is copolymerizable with the methacrylic acid ester is a methyl acrylate and/or an ethyl acrylate.

5. The molded article according to claim 1, wherein the joining portion is a projection structure.

6. The molded article according to claim 5, wherein the projection structure is any one selected from the group consisting of a snap-fit male element, a positioning column, boss, or rib, an engaging male or female portion, and a cylindrical boss for self-tapping.

7. The molded article according to claim 1, wherein the joining portion is a through hole structure or a non-through hole structure.

8. The molded article according to claim 7, wherein the through hole structure or the non-through hole structure is any one selected from the group consisting of a snap-fit female element, a through hole for self-tapping, a non-through hole for self-tapping, and a female portion for press fitting.

9. The molded article according to claim 1, wherein the molded article is any one selected from the group consisting of interior or exterior members for vehicles, lens covers, housing members, and lighting covers.

10. The molded article according to claim 1, wherein the molded article is any interior or exterior member for vehicles selected from the group consisting of visors, dashboard panels, display parts, pillars, head lamp covers, tail lamp covers, side lamp covers, tail lamp garnishes, front lamp garnishes, pillar garnishes, front grilles, rear grilles, and number plate garnishes.

11. The molded article according to claim 1, wherein the molded article is any exterior member for vehicles selected from the group consisting of visors, pillars, head lamp covers, tail lamp covers, side lamp covers, tail lamp garnishes, front lamp garnishes, pillar garnishes, front grilles, rear grilles, and number plate garnishes.
